(19) United States
(12) Patent Application Publication
(10) Pub. No.: US 2006/0184756 A1
(43) Pub. Date: Aug. 17, 2006

(54) Semiconductor memory module for improvement of signal integrity

(76) Inventors: Srdjan Djordjevic, Munchen (DE); Siva RaghuRam, Germering (DE)

Correspondence Address: EDELL, SHAPIRO & FINNAN, LLC, 1901 RESEARCH BLVD., SUITE 400, ROCKVILLE, MD, 20850, US

(21) Appl. No.: 11/354,236

(22) Filed: Feb. 15, 2006

(30) Foreign Application Priority Data
Feb. 15, 2005 (DE) 102005006831.6

(51) Int. Cl. G06F 13/00

(52) U.S. Cl. 711/167

(57) ABSTRACT

A semiconductor memory module has a module board on both sides of which semiconductor memory components are arranged and on an upper face of which a control component is arranged. The control component is connected to the semiconductor memory components via a module bus and bus spurs. The bus is a command address bus using fly-by topology. A semiconductor memory component is connected to the control component via a bus spur that is connected from a junction point to the two symmetrically arranged semiconductor memory components. An additional resistor between line sections of the bus spur reduces fluctuations of address signal levels on the CA bus and thus improves the signal integrity.

### CROSS REFERENCE TO RELATED APPLICATIONS

This application claims priority under 35 U.S.C. §119 to German Application No. DE 102005006831.6, filed on Feb. 15, 2005, and titled “Semiconductor Memory Module for Improvement of Signal Integrity,” the entire contents of which are hereby incorporated by reference.

### FIELD OF THE INVENTION

The present invention relates to a semiconductor memory module with a bus architecture for improvement of signal integrity.

### BACKGROUND

FIG. 4A shows a semiconductor memory module M which, for example, is in the form of an FBDIMM (Fully Buffered Dual-In Line Memory Module). The FBDIMM module has a module board MP with a surface O1, for example an upper face of the module board, and a surface O2, for example a lower face of the module board. A control component SB, which contains a drive circuit AS, is arranged at a central position on the upper face O1. The drive circuit is included on a hub chip HC. The drive circuit AS is used to drive semiconductor memory components.

The semiconductor memory components At, Bt, Ct and Dt are arranged on the upper face O1, to the right of the control component SB. The semiconductor memory components Ab, Bb, Cb and Db are arranged on the lower face O2. The semiconductor memory components are arranged on the first surface and on the second surface such that two semiconductor memory components are opposite one another. A semiconductor memory component E, which in addition to its memory functionality also includes a circuit for error correction ECC (Error Correction Circuit), is arranged on the lower face O2 of the module board MP, opposite the control component SB on the upper face O1. The semiconductor memory component E can be used to correct errors which have occurred when writing or reading data to or from the semiconductor memory components on the upper face and lower face of the module board.

Memory chips are located within the semiconductor memory components and contain memory cells, for example DRAM (Dynamic Random Access Memory) memory cells, for storage of a data item. FIG. 4B shows a simplified illustration of a detail of a memory cell array SZF, which is provided on each of the memory chips. DRAM memory cells SZ are arranged like a matrix along word lines WL and bit lines BL within the memory cell array SZF. A DRAM memory cell has a selection transistor AT and a storage capacitor SC.

In order to read information from the memory cell or to write information to the memory cell, the selection transistor AT is switched on by an appropriate control signal on the word line WL. In this case, the storage capacitor SC is connected to the bit line BL with a low impedance. When a read access is made, the state of charge of the storage capacitor can thus be read via the bit line BL and, when a write access is made, a state of charge can be stored in the storage capacitor.

The hub chip HC as well as the memory chips are each accommodated in a ball grid array package G. The individual components are soldered to the upper face O1 or to the lower face O2 of the module board MP via ball contacts B. The module board MP is in the form of a multilayer printed circuit board. In the example in FIG. 4a, the circuit board has two outer layers L1, L2 as well as an inner layer L3. The control component SB and the semiconductor memory components At, Bt, Ct and Dt are each arranged with their ball contacts on the surface of the outer layer L1. The semiconductor memory components Ab, Bb, Cb, Db and E are arranged on the upper face of the outer layer L2.

FIG. 5 shows a schematic illustration of the connection of the drive circuit AS of the control component SB to the semiconductor memory components At, Ab, Bt, Bb, Ct, Cb, Dt and Db on the right-hand side of the control component, and the connection of the drive circuit AS to the semiconductor memory component E. The output side of the drive circuit AS is connected to the module bus MB. The module bus runs in the inner layer L3 of the module board and has various junction points V1, V2, V3, V4 and V5, which are connected to one another via individual conductor track sections SH.

The drive circuit AS is connected to a junction point V1 via a conductor track section. A bus spur BZ2 branches off from the junction point V1 and is used to connect the drive circuit AS to the semiconductor memory component E. The junction point V1 is connected to the junction point V2 via a further conductor track section of the module bus MB. The junction point V2 is connected via a bus spur BZ1 to the semiconductor memory component Dt on the upper face of the module board. In the same way, junction point V2 is connected via a bus spur BZ2 to the semiconductor memory component Db on the lower face of the module board. Further bus spurs branch off symmetrically from the further junction points V3, V4 and V5, and connect the junction point V3 to the semiconductor memory components Ct and Cb, the junction point V4 to the semiconductor memory components Bt and Bb, and the junction point V5 to the semiconductor memory components At and Ab. The module bus MB is connected to a voltage source Vtt via a resistor R_{MB}.

The module bus MB and the bus spurs BZ1, BZ2 and BZ3 are arranged as shown in FIG. 5, using a so-called fly-by topology. With this type of bus topology, the semiconductor memory components on the left-hand and right-hand side of the control component SB and the semiconductor memory component E underneath the control component SB are connected to the drive circuit AS via a common module bus. In contrast to a so-called point-to-point topology, in which the semiconductor memory components are arranged in series on a bus, the drive circuit drives a plurality of semiconductor memory components in parallel via the junction points.

The module bus and the bus spurs between the control component and the individual semiconductor memory components are in the form of a so-called “Command Address Bus” (CA Bus). Addresses are transmitted on this bus from the drive circuit AS in only one direction to the semiconductor memory components and to the semiconductor memory component. The bus is thus unidirectional.

A plurality of memory chips are in general arranged stacked within the semiconductor memory components. In the case of a so-called “Dual-Stacked” FBDIMM, by way of example, two memory chips are arranged stacked within one semiconductor memory component. In the case of a “Quad-Stacked” arrangement, as is shown in FIG. 5, four memory chips SC1, SC2, SC3 and SC4 are arranged stacked within each semiconductor memory component.

An FBDIMM component is normally configured using the 2R×4 configuration (two “Ranks” of the data organization form×4) or in the 8R×8 configuration (eight “Ranks” of the data organization form×8). A “Rank” is the set of memory components which is required in order to cover the bus width for a memory controller. In the 2R×4 configuration, each of the two “Ranks” comprises 18 memory chips, so that a total of 36 memory chips are driven by the hub chip. If, as is illustrated in FIG. 4A, a total of 18 semiconductor memory components are located on the memory board MP, then each semiconductor memory component contains two memory chips (Dual Stacked).

If the FBDIMM memory module is operated in the 8R×8 configuration, then one “Rank” comprises 9 memory chips. The configuration with 8 “Ranks” accordingly has 72 memory chips. 72 memory chips are distributed over the 18 semiconductor memory components demonstrated in FIG. 4A, with four memory chips being arranged in each of the semiconductor memory components 4 (Quad-Stacked). In the case of the 8R×8 configuration, the hub chip thus drives 72 memory chips.

FIGS. 6A, 6B, and 6C show the signal integrity of address signals which are supplied to the CA bus, to the semiconductor memory component E as well as the semiconductor memory components Dt and Db with an 8R×8 configuration at an operating frequency of 200 MHz. The large number of curves is due to the simultaneous driving of the semiconductor memory components with address signals from the drive circuit AS for the hub chip HC. Each of the illustrations shows eye diagrams of address signals which have been recorded at an address input of one memory chip, which is located within a semiconductor memory component with a “Quad-Stacked” configuration, at the uppermost position in the stack. In order to reliably identify an address signal, the eye diagram must have an aperture of at least 75%.

If the input amplifier of the memory chip is intended to reliably identify a logic high level, the address signal must not be below a level of 0.9 V+125 mV. In order to reliably identify a logic low level of the address signal, the address signal at the input connection of an input amplifier for the memory chip must not be less than a level of 0.9 V−125 mV. In FIG. 6A, this condition is satisfied only for approximately 58% of the time within the time window of the eye diagram from 0 ns to 5 ns. Reliable detection of the signal levels of the address signals is thus no longer ensured at an operating frequency of 200 MHz.

FIG. 6B shows the address signals which are present at the address input of the memory chip which is arranged in the uppermost layer of the “Quad-Stack” within the semiconductor memory component Dt. The limit value level of 0.9 V±125 mV is infringed in this case as well, at about 1 V. The eye diagram has a measured aperture of 58%. The limit values are likewise infringed at times between 0.8 and 1.5 ns at the memory chip which is arranged in the uppermost layer of the “Quad Stack” within the semiconductor component Db. The eye diagram in FIG. 6C has a measured aperture of 51%.

Even at a relatively low frequency of about 200 MHz, it is thus not possible to preclude the possibility of misinterpretations of address signals on the CA bus. The severe fluctuations in the address levels of address signals on the CA bus are due to reflections of the address signals at the junction points and at the semiconductor memory components. A further problem is the heavy load which the hub chip has to drive. In the case of an 8R×8 configuration, it drives 72 memory chips. A further reason for the severe level fluctuations of the address signals is the asymmetric load which the semiconductor memory component E represents on the CA bus, since no semiconductor memory component constructed in the same way is arranged on the opposite surface of the module board. Instead of this, the hub chip is arranged above the semiconductor memory component E on the upper face 01.

As FIG. 6A shows, the semiconductor memory component E, in particular, is subject to severe fluctuations of the address signals. The main reason for this is that there is only a short line section of the bus with a length of about 1 mm between the hub chip and the semiconductor memory component E. The large amount of energy which the hub chip requires to drive the 72 components is thus transmitted directly to the semiconductor memory component E. Furthermore, all of the address signals which run back to the hub chip after reflection at the respective semiconductor memory components are superimposed at the semiconductor memory component E.

### SUMMARY

The present invention provides a semiconductor memory module in which the signal integrity of signals which are transmitted on a bus between a control component and the semiconductor memory components is improved. According to an exemplary embodiment of the present invention, a semiconductor memory module having a module board with a first surface and a second surface includes a plurality of semiconductor memory components, a control component for controlling the semiconductor memory components, and a module bus with junction points. The control component in the semiconductor memory module preferably contains a hub chip. The control component is arranged at a point on the first surface of the module board. A first of the semiconductor memory components is arranged on the first surface of the module board adjacent the control component. A second of the semiconductor memory components is arranged at a point on the second surface of the module board which is opposite the point where the control component is located on the first surface of the module board. The second of the semiconductor memory components may contain, for example, a circuit unit for error correction for the semiconductor memory components.

The control module is connected via the module bus to each of the semiconductor memory components. A bus spur branches off from each of the junction points of the module bus and connects each of the junction points to one of the semiconductor memory components. A first bus spur branches off from one of the junction points and connects the first of the semiconductor memory components to the first of the junction points. Furthermore, a second bus spur branches off from the same junction point and connects the second of the semiconductor memory components to the junction point.

One development of the semiconductor memory module provides a third of the semiconductor memory components adjacent the second of the semiconductor memory components on the second surface of the module board at a point which is opposite the point at which the first of the semiconductor memory components is located on the first surface of the module board. A third bus spur branches off from the same junction point as the first and second spur branches and connects the third of the semiconductor memory components to the junction point.

The module board of the semiconductor memory module is preferably in the form of a multilayer printed circuit board with a first outer layer which is adjacent to the first surface, with a second outer layer which is adjacent to the second surface, and with at least one third layer which is arranged between the first and the second outer layer (i.e., an inner layer). In accordance with one embodiment, the module bus runs in the inner layer, the first bus spur runs in the first outer layer, the second bus spur runs in the inner layer, and the third bus spur runs in the second outer layer.

Optionally, the second bus spur can include a resistor, which can be a buried resistor or an SMD resistor, for example. The module bus preferably has a resistance of approximately 50 ohms. The resistor in the second bus spur preferably has a value of approximately 20 ohms.

The semiconductor memory components of the semiconductor memory module may contain dynamic memory cells of the random access type. According to one embodiment of the semiconductor memory module, each of the semiconductor memory components contains two stacked DRAM memory chips. According to another embodiment of the semiconductor memory module, each of the semiconductor memory components contains four stacked DRAM memory chips.

One development of the semiconductor memory module according to the invention provides for the module bus and the bus braches to be in the form of unidirectional buses for the transfer of address signals.

In one embodiment of the semiconductor memory module, the semiconductor memory components have a ball grid array package.

According to a further design of the semiconductor memory module, the junction points of the module bus are located in vias in the module board.

The module board according to the invention increases the length of the second of the bus spurs, which connects the hub chip to the second of the semiconductor memory components. Consequently, the feedback of the signals on the second of the bus spurs is attenuated such that an address signal which is present at the second of the semiconductor memory components has a largely stable level profile. The lengthening of the connecting path between the hub chip and the second of the semiconductor memory components then provides space to arrange an SMD resistor, for example, on the lower face of the module board in the second of the bus spurs. This measure makes it possible to further minimize reflections of signals on the second of the bus spurs. The resistor acts as a limiter in the system.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The invention will be explained in more detail in the following text with reference to the figures which illustrate exemplary embodiments of the present invention.

FIG. 1 shows an FBDIMM semiconductor memory module with a bus architecture that improves signal integrity according to an exemplary embodiment of the invention.

FIG. 2 shows a cross section through a multilayer module board with a bus architecture according to an exemplary embodiment of the invention.

FIG. 3A shows an eye diagram of address signals at a semiconductor memory component according to an exemplary embodiment of the invention.

FIG. 3B shows a further eye diagram of an address signal at a further semiconductor memory component according to an exemplary embodiment of the invention.

FIG. 3C shows a further eye diagram of an address signal at a further semiconductor memory component according to the invention.

FIG. 4A shows an arrangement of components on an FBDIMM semiconductor memory module.

FIG. 4B shows an arrangement of a memory cell array with a DRAM memory cell.

FIG. 5 shows a conventional architecture of a command address bus of an FBDIMM semiconductor memory module.

FIG. 6A shows an eye diagram of address signals at a semiconductor memory component of the memory module of FIG. 5.

FIG. 6B shows a further eye diagram of address signals at a further semiconductor memory component of the memory module of FIG. 5.

FIG. 6C shows a further eye diagram of address signals at a further semiconductor memory component of the memory module of FIG. 5.

### DETAILED DESCRIPTION

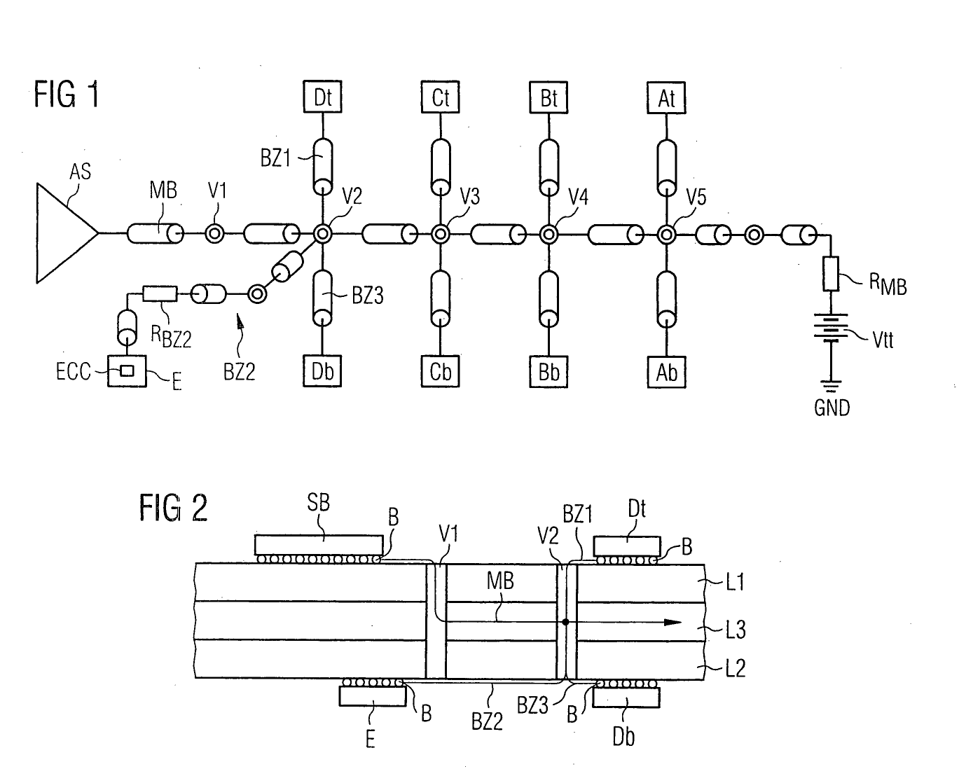

FIG. 1 shows a schematic illustration of a drive circuit AS of a hub chip which is connected via a module bus MB using a fly-by topology to a semiconductor memory component E and to the semiconductor memory components At, Ab, Bt, Bb, Ct, Cb, Dt, and Db. The module bus MB is connected via a terminating resistor R_{MB} to a voltage source Vtt. The module bus MB has junction points V1, V2, V3, V4 and V5, from each of which a bus spur BZ1 branches off to the semiconductor memory components on the upper face O1 of the module board MP, and from each of which a bus spur BZ3 branches off to a semiconductor memory component on the lower face O2 of the module board MP.

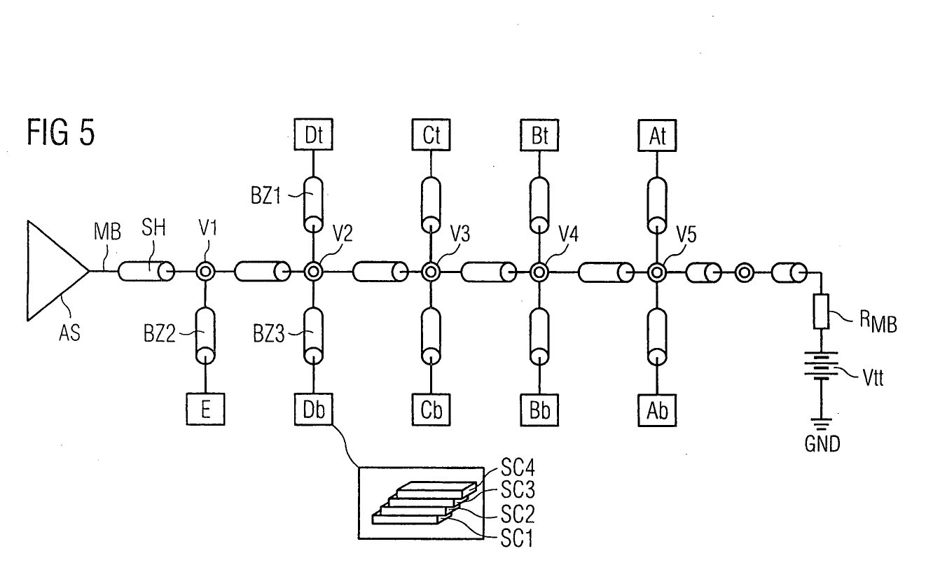

In contrast to FIG. 5, the semiconductor memory component E is not connected to the drive circuit AS via the junction point V1 which is located closest to the drive circuit AS for the hub chip. Instead of this, the bus spur BZ2, which leads back to the semiconductor memory component E, is additionally located at the junction point V2 as well as the bus spurs BZ1 and BZ3. The bus spur BZ2 has a resistor R_{BZ2} between its conductor track sections. If the resistor R_{MB} in the module bus has a resistance value of approximately 50 ohms, then the resistor R_{BZ2} in the bus spur BZ2 preferably has a resistance of about 20 ohms.

FIG. 2 shows a cross section through a multilayer module board MP. The module board comprises the layers L1, L2, and L3. The illustration shows a detail on the right-hand side of the module board. The control component SB and the semiconductor memory component Dt are arranged on the upper face, which is adjacent to the layer L1. The semiconductor memory component E is arranged on the lower face, includes the error correction circuit and is located on the opposite side to the control component SB. The semiconductor memory component Db is arranged alongside (i.e., next to or adjacent) the semiconductor memory component E. The module board has a continuous via V1 and a continuous via V2. The continuous vias each extend from the upper face of the module board to the lower face of the module board.

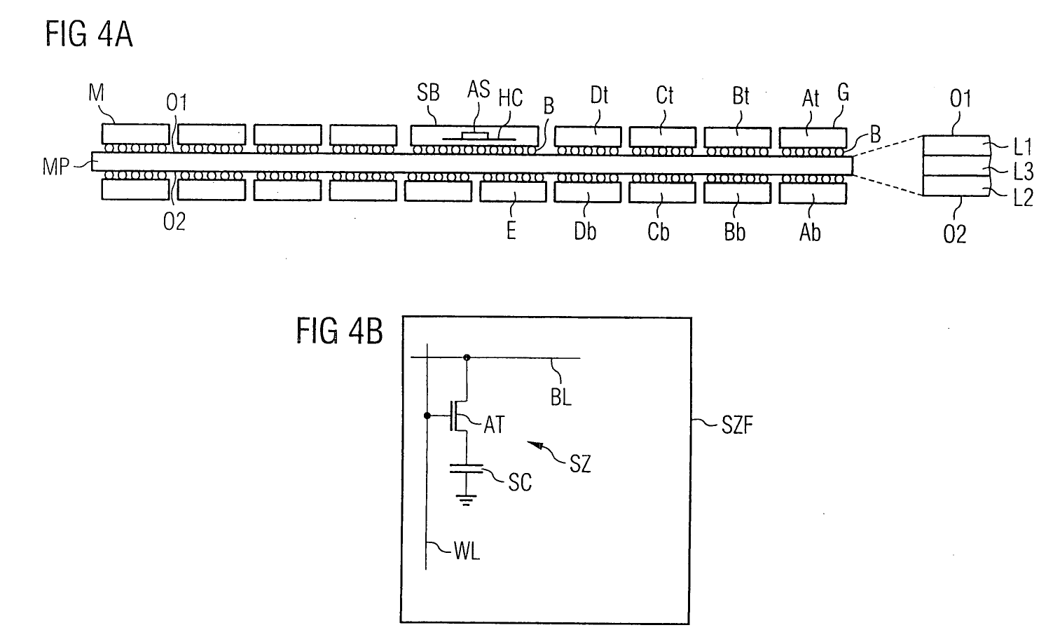

The further semiconductor memory components Ct, Bt and At are arranged alongside (adjacent) the semiconductor memory component Dt. Further continuous vias V3, V4 and V5 are located between them. The further semiconductor memory components Cb, Bb and Ab in FIG. 4 are arranged on the lower face of the module board, alongside (adjacent) the semiconductor memory component Db. The continuous vias V3, V4 and V5, which run from the upper face of the module board to the lower face of the module board, occur between them. These further structures are not illustrated in FIG. 2, for the sake of simplicity.

One of the ball contacts B of the control component SB is connected to the module bus MB. The module bus runs over a short conductor track section from the control component SB to the continuous via V1. The module bus continues within the via V1 to the inner layer L3. The module bus then continues to run along the inner layer L3 to the next via V2 where it branches via a bus spur BZ1 to the surface of the module board, from where it is passed over a short conductor track section to the semiconductor memory component Dt. A further bus spur BZ3 leads to the lower face of the module board, and from there over a short conductor track section to the semiconductor memory component Db. The bus spur BZ2 likewise runs through the via V2 and connects the module bus MB to the semiconductor memory component E via the lower face of the module board.

The bus spur BZ2 can also be continued within one layer of the multilayer module board. The resistor R_{BZ2} is either in the form of an SMD resistor on the lower face of the module board, or in the form of a buried resistor within one of the inner layers.

The proposed modification of the CA bus considerably reduces fluctuations of signal levels compared with those in FIG. 5, in the present case fluctuations of levels of address signals which are transmitted on the module bus MB. This applies not only to the signal levels of the address signals which are supplied via the bus spurs BZ1 to the semiconductor memory components At, Bt, Ct, and Dt on the upper face O1 of the module board MP but also to address signals which are supplied via the bus spurs BZ3 to the semiconductor memory components Ab, Bb, Cb and Db on the lower face O2 of the module board MP. Furthermore, the level fluctuations of the address signals which are supplied to the semiconductor memory component E via the bus spur BZ2 with the resistor R_{BZ2} are also considerably reduced.

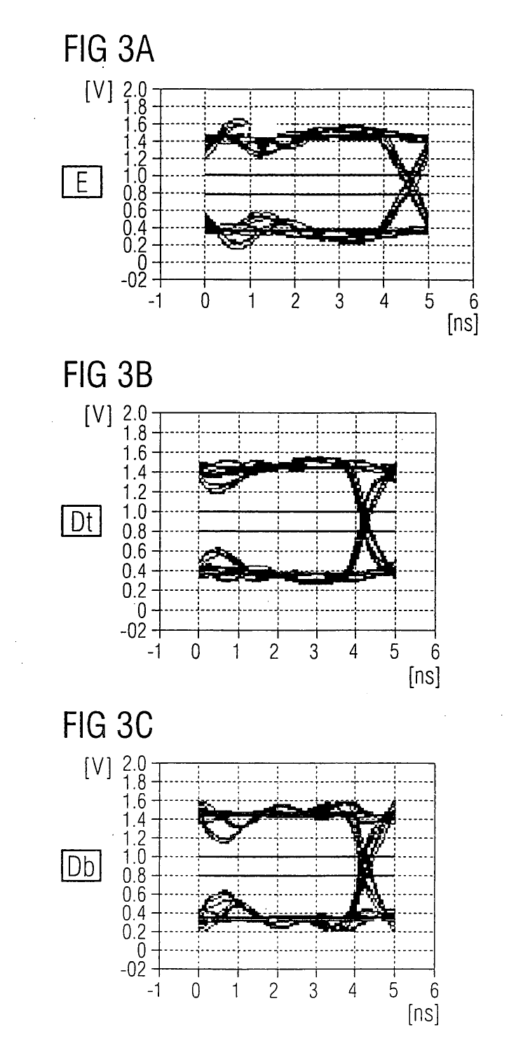

The eye diagrams in FIGS. 3A, 3B, and 3C show the profiles of levels of address signals at address inputs of memory chips of the semiconductor memory components Dt, Db, and E in an 8R×8 configuration at an operating frequency of 200 MHz.

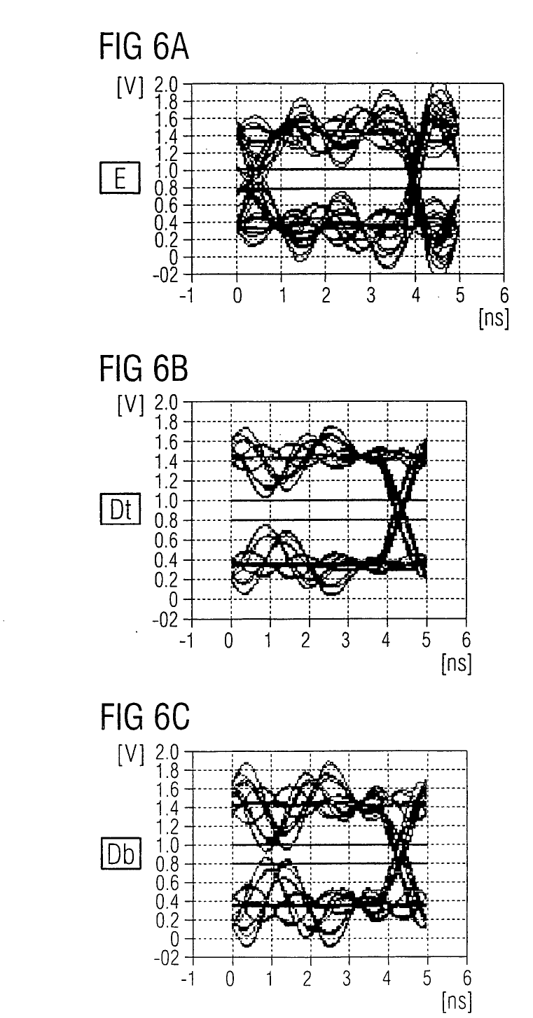

FIG. 3A shows an eye diagram of address signals at the address input of an input amplifier of a memory chip which is arranged in a “Quad-Stacked” arrangement within the semiconductor memory component E in the uppermost layer. In contrast to FIG. 6A, the level fluctuations of the address signals which are transmitted simultaneously from the drive circuit AS to all of the semiconductor memory components are considerably reduced. The eye diagram in FIG. 3A has an aperture of 86% with a time window of 5 ns under conditions in which the FBDIMM memory module operating frequency is 200 MHz. Since even a 75% aperture is sufficient for reliable identification of the signal levels, the bus architecture of the CA bus according to the invention ensures reliable operation of the semiconductor memory module.

FIG. 3B shows the profile of address signals at the address input of a memory chip which is arranged within the semiconductor memory component Dt in the uppermost layer of the “Quad Stack”.

FIG. 3C shows an eye diagram of address signals at the address input of a semiconductor memory chip which is arranged within the semiconductor memory component Db in the uppermost layer of the “Quad Stack”.

The eye diagram in FIG. 3B has an aperture of 89%, and the eye diagram in FIG. 3C has an aperture of 88%. As can also be seen, neither the limit level of 0.9 V+125 mV for reliable detection of the logic high level nor the limit value of 0.9 V−125 mV for reliable detection of the logic low level is any longer infringed in the eye diagrams in FIGS. 3A, 3B, and 3C.

The modification to the CA bus shown in FIG. 1 thus makes it possible to increase the signal integrity of signals on the “Command Address Bus” of which address signals are transmitted between the hub chip and the semiconductor memory components. The fluctuations of address levels on the CA bus are reduced by a bus spur BZ2 running back to the semiconductor memory component E, which is arranged on the lower face of the control component, from a junction point which is further away than that in FIG. 5. This increases the length of the bus between the hub chip and the semiconductor memory component E, thus leading to a reduction in the level fluctuations at the address input of the memory chips of the semiconductor memory component E.

The greater length of the bus spur BZ2 makes it is possible to additionally arrange a resistor between the conductor track sections of the bus spur BZ2. Depending on the space conditions, the resistor may be in the form of an SMD resistor or else, if little space is available, a buried resistor. The buried resistor is implanted in a conductor track in the inner layer L3 of the multilayer module board. Consequently, no additional space is consumed.

The resistor R_{BZ2} is connected in series with the conductor track sections of the bus spur BZ2. In this case, the resistor has the advantage that it acts as a limiter in the system, reducing the level fluctuations by virtue of feedback on the CA bus.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

### LIST OF REFERENCE SYMBOLS

Ab, Bb, Cb, Db, E Semiconductor memory components on the lower face of a module board
AS Drive circuit
At, Bt, Ct, Dt Semiconductor memory components on the upper face of a module board
B Ball contact
BZ Bus spur
ECC Error correction circuit
G Ball grid array package
L Layer
MB Module bus
MP Module board
R_{BZ2} Resistor in the bus spur BZ2
R_{MB} Resistor in the module bus
SB Control component
SC Memory chip
SH Conductor track section
V Junction point, via

What is claimed is:

1. A semiconductor memory module for improving signal integrity, comprising:
a module board with a first surface and a second surface;
a plurality of semiconductor memory components arranged on the first and second surfaces of the module board;
a control component, arranged on the first surface of the module board, for controlling the semiconductor memory components, wherein a first of the semiconductor memory components is arranged on the first surface of the module board adjacent the control component, and a second of the semiconductor memory components is arranged at a point on the second surface of the module board that is opposite a point on the first surface of the module board where the control component is located; and
a module bus coupled to the control component and including a plurality of junction points from which bus spurs branch off the module bus and connect to semiconductor memory components, thereby connecting the control component to each of the semiconductor memory components, wherein a first bus spur branches off from one of the junction points and connects the first of the semiconductor memory components to said one of the junction points, and a second bus spur branches off from said one of the junction points and connects the second of the semiconductor memory components to said one of the junction points.

2. The semiconductor memory module of claim 1, wherein:
a third of the semiconductor memory components is arranged on the second surface of the module board adjacent the second of the semiconductor memory components at a point that is opposite a point at which the first of the semiconductor memory components is located on the first surface of the module board; and
a third bus spur branches off from said one of the junction points and connects the third of the semiconductor memory components to said one of the junction points.

3. The semiconductor memory module of claim 2, wherein:
the module board comprises a multilayer printed circuit board including a first outer layer that is adjacent to the first surface, a second outer layer that is adjacent to the second surface, and at least one inner layer arranged between the first and the second outer layer;
the module bus extends through the at least one inner layer;
the first bus spur extends through the first outer layer;
the second bus spur extends through the at least one inner layer; and
the third bus spur extends through the second outer layer.

4. The semiconductor memory module of claim 1, wherein the second bus spur comprises a resistor.

5. The semiconductor memory module of claim 4, wherein:
the module bus has a resistance of approximately 50 ohms; and
the resistor of the second bus spur has a resistance of approximately 20 ohms.

6. The semiconductor memory module of claim 4, wherein the resistor of the second bus spur comprises a buried resistor.

7. The semiconductor memory module of claim 4, wherein the resistor of the second bus spur comprises an SMD resistor.

8. The semiconductor memory module of claim 1, wherein the control component includes a hub chip.

9. The semiconductor memory module of claim 1, wherein the semiconductor memory components include dynamic random access memory cells.

10. The semiconductor memory module of claim 9, wherein each of the semiconductor memory components includes two stacked DRAM memory chips.

11. The semiconductor memory module of claim 9, wherein each of the semiconductor memory components includes four stacked DRAM memory chips.

12. The semiconductor memory module of claim 1, wherein the second of the semiconductor memory components includes a circuit unit for error correction for the semiconductor memory components.

13. The semiconductor memory module of claim 1, wherein the module bus and the bus spurs comprise unidirectional buses for the transfer of address signals.

14. The semiconductor memory module of claim 1, wherein the semiconductor memory components include a ball grid array package.

15. The semiconductor memory module of claim 1, wherein the junction points of the module bus are located in vias in the module board.
